(19) United States
(12) Patent Application Publication
(10) Pub. No.: US 2008/0097979 A1
(43) Pub. Date: Apr. 24, 2008

(54) SYSTEM AND METHOD OF FINDING RELATED DOCUMENTS BASED ON ACTIVITY SPECIFIC META DATA AND USERS' INTEREST PROFILES

(75) Inventors: Niklas Heidloff, Salzkotten (DE); Mike O'Brien, Westford, MA (US)

Correspondence Address: CANTOR COLBURN LLP - IBM LOTUS, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/550,895

(22) Filed: Oct. 19, 2006

(51) Int. Cl. G06F 17/30

(52) U.S. Cl. 707/5

(57) ABSTRACT

A system and method of finding related documents based on activity specific meta data and users' interest profiles is described. The method includes searching an information source based upon a user's interest profile; a search query; and a contextual setting. Additionally, the method includes calculating a priority value for each item of the search result, sorting the items of the search result according to the priority value, and displaying the sorted search result to the user.

IBM OR is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the invention

The invention relates to computerized searching. More specifically, the invention relates to searching documents and displaying the results of the search based on contextual information and interest profiles associated with a user.

2. Description of the Related Art

Search utilities are common throughout various computing environments such as the world-wide-web and in various computer applications such as electronic mail, word processing, and other desktop applications. A large number of computer users still only enter a single search term into the search utility, because complex search queries are difficult for the average computer user to construct. As a result, the search utility often returns an overwhelming amount of data that satisfies the search query. The user manually sorts through the search results to find the desired information.

To address this problem, programmers developed various mechanisms to aid computer users in constructing search queries. One such mechanism is Query by Example (QBE), which is a method of query creation that allows the computer user to search for documents based on an example in the form of a selected text string, a document name, or a list of documents. Because the QBE system formulates the actual query, QBE is easier to learn than formal query languages, such as the standard Structured Query Language (SQL), and can produce powerful searches. For example, in QBE the location of the user's cursor on a computer display can be used to determine if the user is looking at his or her calendar program. The user can highlight a term of calendar entry and ask the QBE mechanism to search for other documents containing that term.

Often, the result of the QBE is displayed to the user based on a single property (e.g., a date or a keyword). For example, a document containing an exact match of the QBE term is determined to be more likely of interest to the user than a document containing a derivative of the QBE term. Accordingly, the result of the QBE is displayed to the user based upon this assumption. However, in some circumstances the user may actually be more interested in the document containing the derivative of the QBE term, because the user may have an upcoming event focused on the derivative QBE term. Basing the QBE search results on a single property often does not produce an accurate reflection of what is important to the user.

In electronic collaborative systems as well as PIM (personal information management) systems users often need to find related documents to their current work. For example a user that reads a mail with the subject ‘organizational announcement’ might also want to read the article ‘organization announcement’ in the internet.

There are different technologies and concepts that propose how to find documents related to the current context of a user. For example, by reading a calendar title, invitees and date of the currently opened calendar entry, i.e., user context, a parametric full text search is executed to find related documents, esp. mails.

However, this approach only searches for direct matches between the current context and other indexed documents. It does not follow the relations in the indexed documents to find other related documents. The approach also does not the use the users' interest profiles, for example, most important terms and/or people to improve the search results.

Therefore, there exists a need for a system and method of finding related documents based on activity specific meta data (i.e., context data) and users' interest profiles

### SUMMARY OF THE INVENTION

In accordance with one embodiment of the invention a related document finding system for retrieving related documents based on activity specific meta data and users' interest profiles is provided. The system includes a context module for providing context of a current document; a user's interest profile module for providing user's interest; and a search engine for providing a search query. The system also includes an organizing module for organizing and prioritizing the search results according to the search query, the user's interest profile, and the context information.

The invention is also directed towards a method of finding related documents, The method includes determining a contextual setting; retrieving a user's interest profile; and entering a search query. The method also includes searching an information source, based on the contextual setting, the user's interest profile, and the search query. In addition, the method prioritizes the search results based upon weighted factors related to the user's interest profile, the context information, and the search query.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the embodiments of the invention described herein, technically we have achieved a solution for a program storage device readable by a machine, tangibly embodying a program of instructions executable by the machine to perform a method for finding related documents. The method includes determining a contextual setting which includes determining a current document's meta data, such as the document's title; author; subject; category; and any keywords that may be associated with the document. The method also includes retrieving a user's interest profile and entering a search query. The program of instructions also include instructions for searching an information source, based on the contextual setting, the user's interest profile, and the search query; and generating a search result. The program of instructions further includes instructions for calculating a priority value for each item of the search result. The priority value is based upon weighting factors related to the contextual setting; the user's interest profile, and the search query

### BRIEF DESCRIPTION OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a block diagram of an embodiment of client-server environment within which the present invention can operate;

FIG. 2 is a conceptual block diagram of a software system according to principles of the invention; and

FIG. 3 is a flow chart of an embodiment of a method of organizing and presenting a search result to a user according to the principles of the invention.

### DETAILED DESCRIPTION OF THE INVENTION

As defined herein, an activity is a collection of links to documents. Activities can contain links to different types of documents. A document can be a shared document from a shared source (e.g. Notes document from Notes team room), it can be a persistent instant message chat stored in a central repository, it could also be a MS word document stored in a content management system, or a mail stored in a server side shared mailbox, etc.

A feature of the present invention is that an activity may be a tree of links. Over these links, potentially related documents can be found to a document that has no direct relations to this other document. This feature could use these links and do matches by comparing words, people and time information.

The following example highlight aspects of this feature:

Activity item one links to document with author ‘Mike O'Brien’

Activity item two links to document with subject ‘Hannover’

Selected/current document subject ‘Hannover’

A search for potentially related documents, in accordance with a feature of the present invention, could now return, for the selected/current document, the document with author ‘Mike O'Brien’ which may not even include the word ‘Hannover’.

Another feature of the present invention uses the users' interest profiles to find related documents. Every user has an interest profile that is calculated automatically and that contains the most important terms and people for a specific user. In order to find better matches the interest profile could be used to improve the search results.

Thus, not only is the context information (e.g. current document author, current document title, etc.) used fro search and prioritizing search results, but also the interest profile, as illustrated in the following example.
Activity item one links to document with author ‘Mike O'Brien’ with subject ‘Hannover’
Activity item two links to document with author ‘Jim Wilson’ with subject ‘Hannover’
Selected/current document subject ‘Hannover’
Current user has a predetermined closer relation to ‘Mike O'Brien’ than ‘Jim Wilson’ according to the user's interest profile.

Thus, in the above example, in accordance with features of the present invention, a document search returns a document in activity item one first or only since it is more likely that it is more important for the current user.

The present invention relates to a software application for searching, organizing, and presenting a result of a dynamically generated search query to a user of the software application. The functionality of the software application can be incorporated into existing applications such as office applications, email applications, and time management applications. Alternatively, the software application of the present invention can be a stand-alone application. The software application retrieves documents from various sources. As used herein, the term documents includes, but is not limited to, e-mail messages, meetings notices, calendar entries, task list items, instant messages, web pages, word processing files, presentation files, spreadsheet files, database records, and the like.

The dynamic search query and its associated result are generated based on a contextual setting of the user. As used herein, the contextual setting for the dynamic search query refers to past, present and future events such as meetings, conference calls, video conferences and the like that are important to the user. Refining functions, which are also based on a contextual setting, operate on the returned results of the search engine to provide further values for ranking the returned search results. A contextual setting for refining refers to all of the personal information of the user, including but not limited to email, events, and documents of the user.

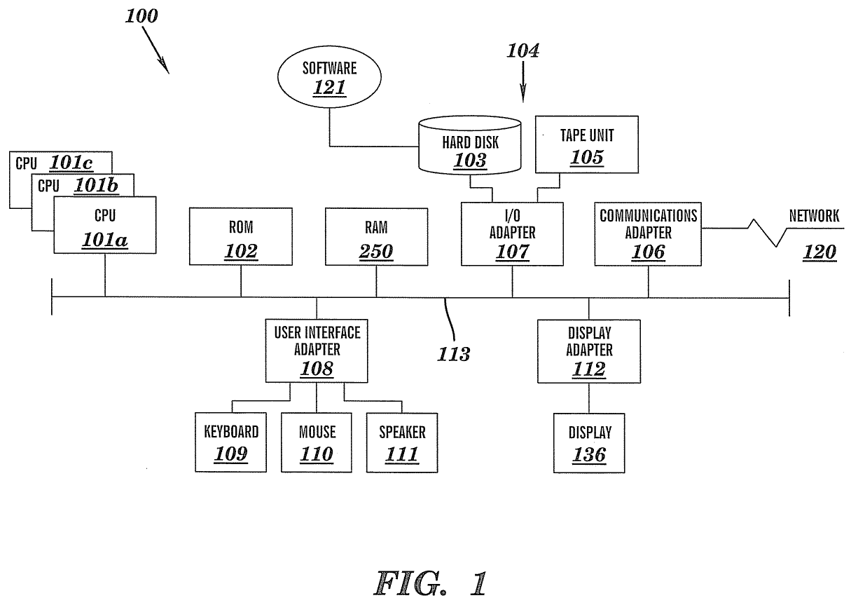

Referring now to FIG. 1, an embodiment of a processing system 100 for implementing the teachings herein is depicted. System 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 250 and various other components via a system bus 113. Read only memory (ROM) 102 is coupled to the system bus 113 and may include a basic input/output system (BIOS), which controls certain basic functions of system 100.

FIG. 1 further depicts an I/O adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. A network adapter 106 interconnects bus 113 with an outside network 120 enabling data processing system 100 to communicate with other such systems. Display monitor 136 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Components Interface (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

As disclosed herein, the system 100 includes machine readable instructions stored on machine readable media (for example, the hard disk 103) for providing for ad-hoc groups as software 121. The software 121 combines the user's interest profiles and the user's contextual information to improve the search results. The final ordering indicates an order of importance or priority to the user.

The software 121 may be produced using software development tools as are known in the art.

Thus, as configured in FIG. 1, the system 100 includes processing means in the form of processors 101, storage means including system memory 250 and mass storage 104, input means such as keyboard 109 and mouse 110, and output means including speaker 111 and display 136. In one embodiment a portion of system memory 250 and mass storage 104 collectively store an operating system such as the AIX® operating system from IBM Corporation to coordinate the functions of the various components shown in FIG. 1.

It will be appreciated that the system 100 can be any suitable computer (e.g., 486, Pentium, Pentium II, Macintosh), Windows-based terminal, wireless device, information appliance, RISC Power PC, X-device, workstation, mini-computer, mainframe computer, cell phone, personal digital assistant (PDA) or other computing device.

Examples of operating systems supported by the system 100 include Windows 95, Windows 98, Windows NT 4.0, Windows XP, Windows 2000, Windows CE, Macintosh, Java, LINUX, and UNIX, or any other suitable operating system. The system 100 also includes a network interface 120 for communicating over a network (not shown) 8. The network can be a local-area network (LAN), a metro-area network (MAN), or wide-area network (WAN), such as the Internet or World Wide Web.

Users of the system 100 can connect to the network 120 through any suitable connection, such as standard telephone lines, digital subscriber line, LAN or WAN links (e.g., T1, T3), broadband connections (Frame Relay, ATM), and wireless connections (e.g., 802.11(a), 802.11(b), 802.11(g)).

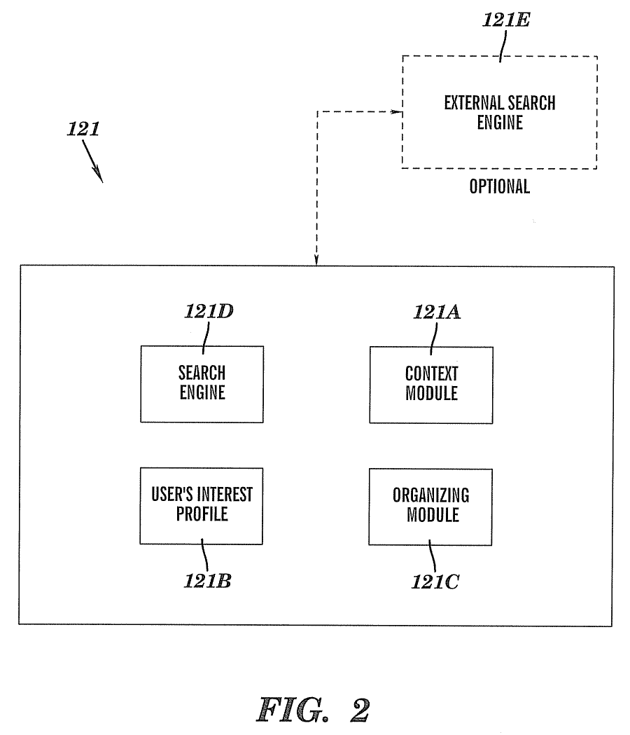

Referring to FIG. 2, there is shown a conceptual block diagram of an embodiment of the related document finder software 121 of FIG. 1. The related document finder 121 includes activity specific meta data (i.e., context module 121A, users' interest profile module 121B, and organizing module 121C). It will be appreciated that the context module 121A may be populated by any suitable means. For example, context may be derived from document parameters as noted above. In addition, the user's interest profile module 121B may also be populated by any suitable means. Both modules may be pre-populated or dynamically populated when a search is initiated.

In general, the related document finder 121 includes a search engine 121D or optionally connectivity to an external search 121E engine for searching through documents in response to a dynamically generated search query. The related document finder 121 includes a searching function for search and identifying documents in accordance with the user's interest profile and the user's context information (e.g., people, dates, and words) in accordance with features of an embodiment of the present invention. An embodiment of the present invention also includes a ranking function for assigning search scores to each document identified by the searching function.

People: For example, every document in an application such as LOTUS NOTES™ has fields that are marked to include person names. For example, every document has an author field, a creator, a last modifier etc. There can also be additional special types of fields in a form including person names.

Dates: document has a creation date and last modification date.

Words: Any suitable text analyzer tool can be used to extract the nouns and the nouns that appear a specified number of times.

A post filter would then use a user's interest profile to change the ranking of the results or even to remove items from the result list.

As an illustrative example, if a calendar entry reads “meet to discuss Windows patch deployment adoption” and lists the participants as Joe Smith, John Price, Fred Randolf, the resulting dynamically generated search query is:
text:meet, text:to, text:discuss, text:windows, text:patch, text:deployment, text:adoption, author: “joe smith”, author: “john price”, author: “fred randolf” sentto: “joe smith”, sentto: “john price”, sendto: “fred randolf.”

In this example, text:x indicates that the body or subject of any returned document should contain text x, author:x indicates that the author of any returned document should contain text x, and sendto:x indicates that any returned document should have been sent to recipient x.

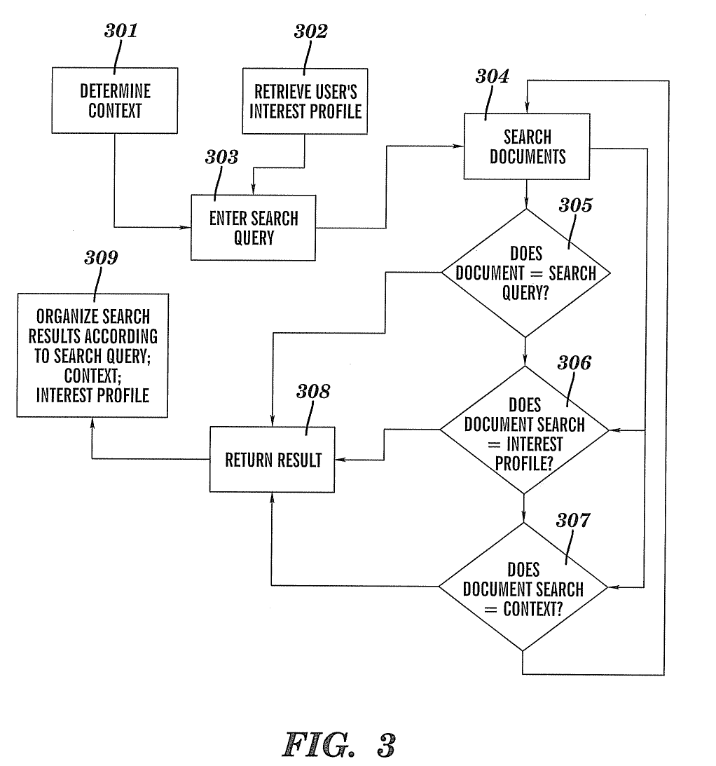

Referring to FIG. 3, there is shown a flow chart of an embodiment of a method of organizing and presenting a search result to a user according to the principles of the invention. Context is determined or retrieved 301 from a predetermined source such as meta data files associated with a document. It will be appreciated however, that context may be determined by any suitable means. Similarly, the user's interest profile is determined or retrieved 301 from a predetermined source such as a user's interest data file. A search query is entered 303 and documents are searched 304 according to the user's interest profile, context, and, of course, the search query. It will also be appreciated that documents searched can be any file, document, listing, email, or title that is electronically searchable. Each document searched is compared with: the search query 305; the user's interest profile 306; and the context 307. If the document matches one or more of the comparisons then the result is returned 308. If the document does not match any of the comparisons then the search is continued 304. At the completion of the search the results are prioritized according search query; user's interest profile; and context 309. It will be understood that the search query; user's interest profile; and context priority may be predetermined and weighted.

While the invention has been shown and described with reference to specific preferred embodiments, it should be understood by those skilled in the art that various changes in form and detail may be made therein without departing from the spirit and scope of the invention as defined by the following claims. For example, although described as a method and data file the invention can be embodied as a computer readable medium (e.g., compact disk, DVD, flash memory, and the like) that is sold and distributed in various commercial channels.

Also, the computer readable instructions contained on the computer readable medium can be purchased and download across a network (e.g., Internet). Additionally, the invention can be embodied as a computer data signal embodied in a carrier wave for organizing and presenting information to a user.

What is claimed is:

1. A method of finding related documents, the method comprising:
determining a contextual setting;
retrieving a user's interest profile;
entering a search query; and
searching at least one information source, wherein the search is based on the contextual setting, the user's interest profile, and the search query.

2. The method as in claim 1 further comprising:
generating a search result;
calculating a priority value for each item of the search result; and
displaying the sorted search result to the user.

3. The method of claim 1 wherein determining the contextual setting further comprises:
determining a current document meta data, wherein determining the current document meta data comprises:
determining document title;
determining document author;
determining document subject;
determining document category; and
determining document keywords.

4. The method of claim 2 wherein calculating the priority value comprises applying a weighting algorithm to each item of the search result, the weighting algorithm comprising weighting factors related to the contextual setting.

5. The method of claim 2 wherein calculating the priority value comprises applying a weighting algorithm to each item of the search result, the weighting algorithm comprising weighting factors related to the user's interest profile.

6. The method of claim 2 wherein calculating the priority value comprises applying a weighting algorithm to each item of the search result, the weighting algorithm comprising weighting factors related to the search query.

7. A program storage device readable by a machine, tangibly embodying a program of instructions executable by the machine to perform a method for finding related documents, the method comprising:
determining a contextual setting, wherein determining the contextual setting further comprises:
determining a current document meta data, wherein determining the current document meta data comprises:
determining document title;
determining document author;
determining document subject;
determining document category;
determining document keywords.;
retrieving a user's interest profile;
entering a search query;
searching at least one information source, wherein the search is based on the contextual setting, the user's interest profile, and the search query;
generating a search result;
calculating a priority value for each item of the search result, wherein calculating the priority value for each item of the search result comprises:
applying a weighting algorithm to each item of the search result, the weighting algorithm comprising weighting factors related to the contextual setting; the user's interest profile, and the search query; and
displaying the sorted search result to the user.

8. A related document finding system for retrieving related documents based on activity specific meta data and users' interest profiles, the system comprising:
a context module for providing context of a current document;
a user's interest profile module for providing user's interest; and
a search engine for providing a search query, wherein the search engine is connectable to the context module and the user's interest profile module.

9. The related document finding system as in claim 8 further comprising a network connection connectable to an external search engine.

10. The related document finding system as in claim 8 further comprising an organizing module for prioritizing documents retrieved in accordance with the context of the current document, the user's interest profile, and the search query.

11. The related document finding system as in claim 10 further comprising a display for displaying the organized results.
